(19) United States
(12) Patent Application Publication
(10) Pub. No.: US 2015/0381034 A1
(43) Pub. Date: Dec. 31, 2015

(54) Charge Pump Device and Driving Capability Adjustment Method Thereof

(71) Applicant: NOVATEK Microelectronics Corp., Hsin-Chu (TW)

(72) Inventor: Hsiang-Yi Chiu, New Taipei City (TW)

(21) Appl. No.: 14/501,060

(22) Filed: Sep. 30, 2014

(30) Foreign Application Priority Data
Jun. 26, 2014 (TW) 103122110

(51) Int. Cl. H02M 3/07

(52) U.S. Cl. CPC H02M 3/07

(57) ABSTRACT

A charge pump device includes a driving stage, for generating a driving signal corresponding to a driving capability, a charge pump circuit, for generating an output voltage according to the driving signal, a comparing circuit, for generating a comparison result according to the output voltage and a reference voltage, a duty cycle detecting circuit, for detecting a length of a duty cycle of an indicating signal indicating the comparing result, to generate a detection result indicating the duty cycle, and a driving capability control circuit, coupled between the duty cycle detecting circuit and the driving stage, for controlling the driving capability corresponding to the driving signal according to the detection result.

### BACKGROUND OF THE INVENTION

1. Field of the Invention

The present invention relates to a charge pump device and driving capability adjustment method thereof, and more particularly, to a charge pump device and driving capability adjustment method thereof capable of adjusting an output driving capability according to a length of a duty cycle related to a comparison result of an output voltage and a reference voltage while balancing both output ripple and loading regulation.

2. Description of the Prior Art

Generally speaking, a charge pump device can be utilized for providing a stable output voltage to different loadings. In the prior art, the charge pump device is controlled by an operational amplifier or by a comparator. Under the structure utilizing the operational amplifier for performing controlling, the output voltage has smaller output ripples but may be unstable under different loadings and different external components. Although the output voltage is stable under the structure utilizing the comparator for controlling, the output voltage has greater periodic output ripples and may have noise in audio frequency band under certain loadings.

For example, please refer to FIG. 1A, which is a schematic diagram of a conventional charge pump device 10. The charge pump device 10 is realized in the structure utilizing the operational amplifier for performing controlling, and comprises a charge pump circuit 102, an operation amplifier 104, an adjusting transistor 106 and a driving stage 108. In brief, the charge pump circuit 102 generates an output voltage VGH according to a driving signal DRVP generated by the driving stage 108. For example, the charge pump circuit 102 may be a Dickson charge pump which controls an input voltage AVDD to charge flying capacitors CF1 and CF2 when the driving signal DRVP is at a low logic level, such that the charges stored in the flying capacitor CF1 and CF2 are outputted to an output capacitor CS1 when the driving signal DRVP is at a high logic level for sharing charges of the flying capacitor CF1 and CF2, to pump the output voltage VGH to a desired voltage level.

As to generating the driving signal DRVP for performing controlling, the voltage dividing resistors R1 and R2 divide the output voltage VGH for generating a feedback voltage FBP to the operational amplifier 104. The operational amplifier 104 compares the feedback voltage FBP and a reference voltage VREF to provide an output signal OP_OUT to the adjusting transistor 106 for performing adjusting the driving capability. Specifically, the feedback voltage FBP becomes higher and the output signal OP_OUT is also pulled high when the output voltage VGH becomes higher, such that the conducting resistance of the adjusting transistor 106 becomes greater (i.e. the gate-source voltage of the adjusting transistor 106 becomes smaller); and the feedback voltage FBP becomes lower and the output signal OP_OUT is pulled low when the output voltage VGH becomes lower, such that the conducting resistance of the adjusting transistor 106 becomes smaller (i.e. the gate-source voltage of the adjusting transistor 106 becomes smaller). Next, the driving stage 108 generates the driving signal DRVP according to the adjusting transistor 106 and a clock signal CLK, for controlling the charge pump circuit 102 to generate the desired output voltage VGH.

In detail, please refer to FIG. 1B, which is a waveform diagram of related signals of charge pump device 10 shown in FIG. 1A. As shown in FIG. 1B, since the driving stage 108 continuously triggers the driving signal DRVP to a high logic level when the clock signal CLK is at a high logic level and the conducting resistance of the adjusting transistor 106 is adjusted according to the output voltage VGH, a smaller charging current of the charge pump circuit 102 generated to the output voltage VGH of the output capacitor CS1 is obtained. Since the ripples of the output voltage VGH are proportional to the charging current, the output voltage VGH therefore has smaller output ripples.

However, since the output of the charge pump device 10 has a pole equals 1/(2π×CS1×loading resistance), the pole varies due to different external loadings and different capacitances of output capacitor CS1, causing the charge pump 10 to be unstable under certain circumstances.

On the other hand, please refer to FIG. 2A, which is a schematic diagram of another conventional charge pump device 20. The charge pump device 20 is partially similar to the charge pump device 10, and thus the same symbols are used for components and signals with similar functions. The charge pump device 20 is controlled by a comparator, and comprises a charge pump circuit 102, a comparing circuit 204, a driving stage 206 and voltage dividing resistors R1 and R2, wherein the comparing circuit 204 comprises a comparator 208, a flip-flop 210 and a NAND gate 212. The operations of the charge pump device 102 pumps the output voltage VGH to the desired level according to the driving signal DRVP generated the driving stage 206 can be referred to the above, and are not narrated herein for brevity.

As to generation of the driving signal DRVP for performing controlling, the voltage dividing resistors R1 and R2 divide the output voltage VGH for generating the feedback voltage FBP to the comparator 208. The comparator 208 compares the feedback voltage FBP and the reference voltage VREF for providing a comparing output signal COMP_OUT, and the flip-flop 210 samples the voltage level of the comparing output signal COMP_OUT at the rising edges of the clock signal CLK and provides a comparing sample signal COMP_SAM (i.e. different from the comparing output signal COMP_OUT which may vary due to noise or interference, the comparing sample signal COMP_SAM stays at the same level during a time period of the clock signal CLK). The NAND gate 212 generates a comparing result signal COMP_SIG to the driving stage 206, such that the driving stage 206 can accordingly toggle the driving signal DRVP for controlling the charge pump circuit 102 to generate the desired output voltage VGH.

In detail, please refer to FIG. 2B, which is a waveform diagram of related signals of the charge pump device 20 shown in FIG. 2A. As shown in FIG. 2B, when the output voltage VGH is lower than a target voltage (i.e. the feedback voltage FBP is smaller than the reference voltage VREF), the comparing sample signal COMP_SAM starts outputting a high logic level for a period starting at a rising edge of the clock signal CLK. When both the comparing sample signal COMP_SAM and the clock signal CLK are at the high logic level (i.e. the comparing result signal COMP_SIG is at the low logic level), the driving signal DRVP is at the high logic level for controlling the charge pump circuit 102 to continuously charge the output voltage VGH. Next, after the output voltage VGH becomes greater than the target voltage, the comparing sample signal COMP_SAM outputs a low logic level for a period starting at another rising edge of the clock signal CLK, to keep the driving signal DRVP at the low logic level for controlling the charge pump device 102 not to charge the output voltage VGH. The output voltage VGH of the output capacitor CS1 is gradually decreased in driving the external loading. The above operations proceed repeatedly until the output voltage VGH is lower than the target voltage. In such a condition, since the charge pump device 20 only compares the feedback voltage FBP and the reference voltage VREF, the output voltage VGH is stable under different loading and capacitor CS1 conditions.

On the other hand, in comparison with the charge pump device 10 triggering the driving signal DRVP to the high logic level when the clock signal CLK is at the high logic level, the charge pump device 20 triggers the driving signal DRVP to high logic level only when both the comparing sample signal COMP_SAM and the clock signal CLK are at the high logic level (the driving signal DRVP is selectively triggered), such that a larger charging current of the charge pump circuit 102 is obtained, leading to larger output ripples.

In detail, the level of the high logic level of the driving signal DRVP relates to the driving capability corresponding to the driving signal DRVP. In the structure of comparator, since the transistors of driving stage 206 are turned fully on, the level of the driving signal DRVP is higher when the driving signal is at the high logic level. On the contrary, in the structure of the operational amplifier, since the output signal OP_OUT of the operational amplifier 104 adjusts the driving capability of the driving stage 108 via adjusting the transistor 106, the level of the driving signal DRVP is lower when the driving signal DRVP is at the high logic level. The driving capability provided by the charge pump circuit 102 is determined by the number of times the driving signal DRVP is triggered to the high logic level and the amplitude of the driving signal DRVP. For different loadings, the comparator structure adjusts the number of times the driving signal DRVP is triggered to the high logic level, while the operational amplifier structure adjusts the amplitude of the driving signal DRVP when the driving signal DRVP is at the high logic level.

When the system is stable, the average charging current of the charge pump circuit 102 for charging the output voltage VGH must equal the loading current, such that the output voltage VGH can be kept at the target level. For the same the loading current, since the driving signal DRVP in the operational amplifier structure is kept toggling while the one in the comparator structure toggles periodically, the charging current of the charge pump circuit 102 in the comparator structure us larger than that in the operational amplifier structure. Furthermore, the output ripples are proportional to the charging current, so the output voltage VGH of the comparator structure therefore has greater periodic output ripple.

In such a condition, although the charge pump device 20 controlled by the comparator does not have problem of stability, the charge pump device 20 has larger output ripples. If the output ripples are reduced via decreasing the driving capability of the driving signal DRVP, the loading driving capability is also decreased, such that the charge pump device 20 may not appropriately drive the loading. Thus, there is a need for improvement of the prior art.

### SUMMARY OF THE INVENTION

It is therefore an objective of the present invention to provide a charge pump device and driving capability adjustment method thereof capable of adjusting an output driving capability according to a length of a duty cycle related to a comparison result of an output voltage and a reference voltage while balancing both output ripple and loading regulation.

A charge pump device is provided. The charge pump device comprises a driving stage, for generating a driving signal corresponding to a driving capability; a charge pump circuit, for generating an output voltage according to the driving signal; a comparison circuit, for generating a comparison result according to the output voltage and a reference voltage; a duty cycle detecting circuit, for detecting a length of a duty cycle of an indicate signal indicating the comparison result of, to generate a detecting result indicating the length of the duty cycle; and a driving capability control circuit, coupled between the duty cycle detecting circuit and the driving stage, for controlling the driving capability corresponding to the driving signal according to the detecting result in an operating period.

A driving capability adjustment method for a charge pump device is provided. The driving capability adjustment method comprises (i) comparing an output voltage of the charge pump device with a reference voltage to generate a comparison result in an operating period; and (ii) detecting a length of a duty cycle of an indicate signal indicating the comparison result of, to set a driving capability to drive the charge pump device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a conventional charge pump device.

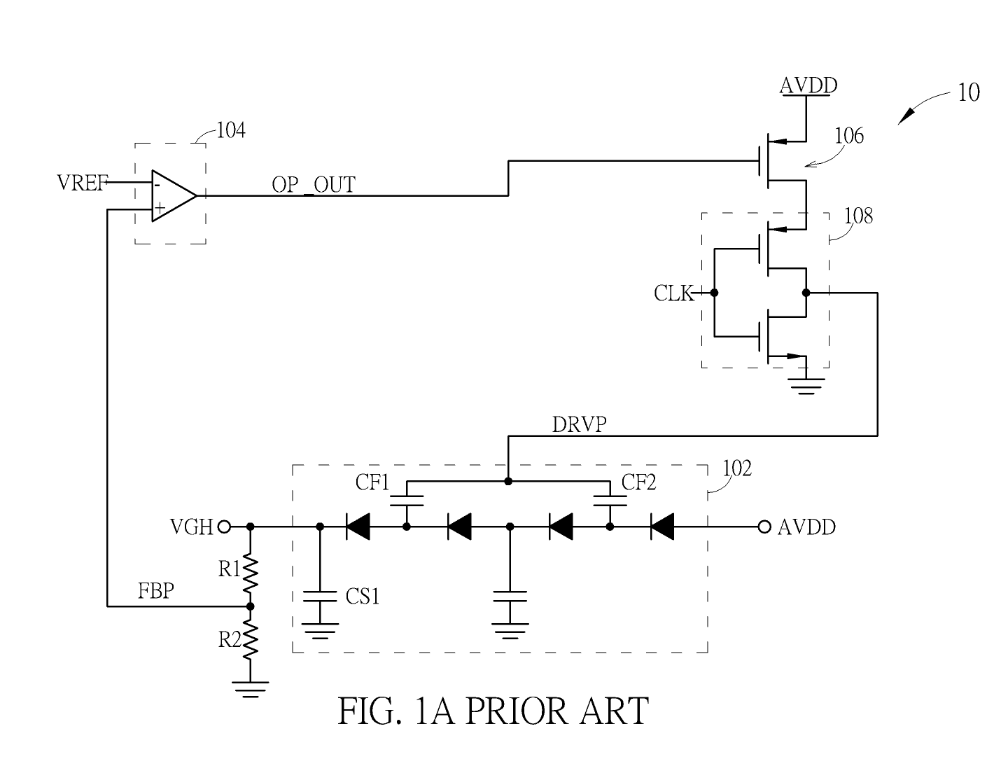

FIG. 1B is a waveform diagram of related signals of the charge pump device shown in FIG. 1A.

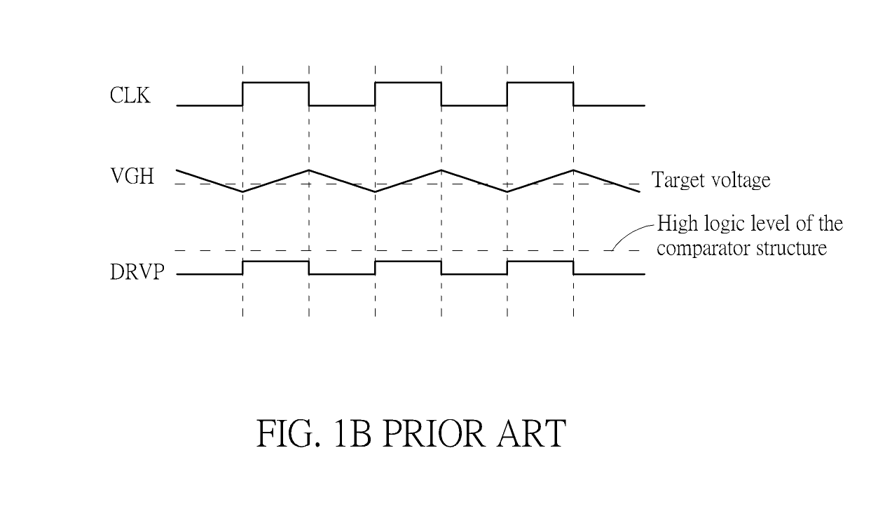

FIG. 2A is a schematic diagram of another conventional charge pump device.

FIG. 2B is a waveform diagram of related signals of the charge pump device shown in FIG. 2A.

FIG. 3A is a schematic diagram of a charge pump device according to an embodiment.

FIG. 3B is a schematic diagram of a duty cycle of an indicating signal under different loads as shown in FIG. 3A according to an embodiment.

FIG. 4 is a schematic diagram of three intervals of a duty cycle according to an embodiment

FIG. 5 is a schematic diagram of a driving capability adjustment process according to an embodiment.

FIG. 6 is a schematic diagram of partial circuit of the charge pump device shown in FIG. 3A according to an embodiment

FIG. 7 is a schematic diagram of partial circuit of the charge pump device shown in FIG. 3A according to another embodiment . . .

### DETAILED DESCRIPTION

In embodiments, charge pump devices and driving capability adjustment method thereof adjust the driving capability of the driving stage via detecting a length of a duty cycle related to a comparison result of an output voltage and a reference voltage, so as to balance both output ripple and loading regulation. The present invention is particularly shown and described with respect to at least one exemplary embodiment accompanied with drawings. Words utilized for describing connection between two components such as couple and connect should not be taken as limiting a connection between the two components to be directly coupling or indirectly coupling.

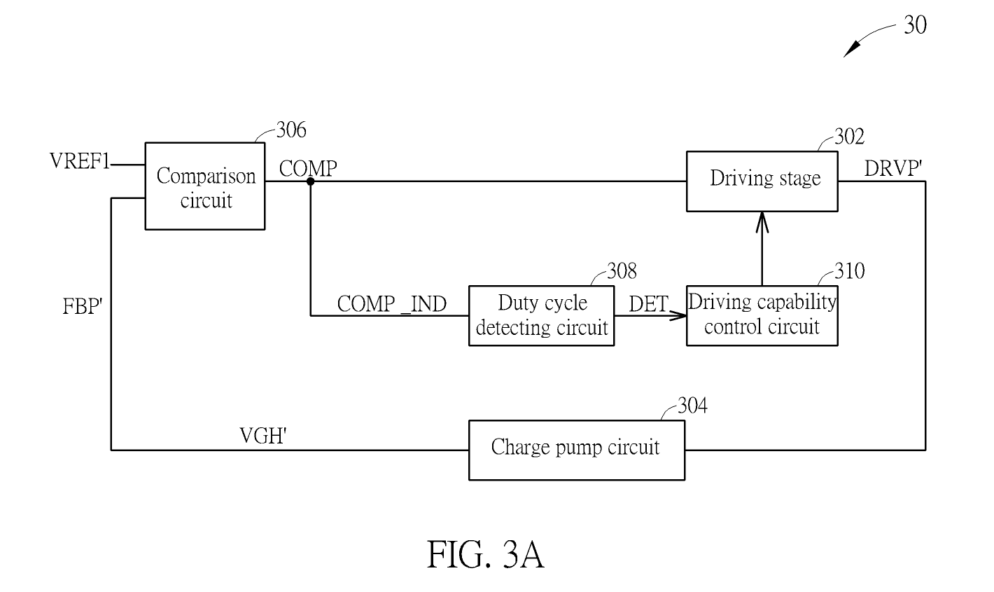

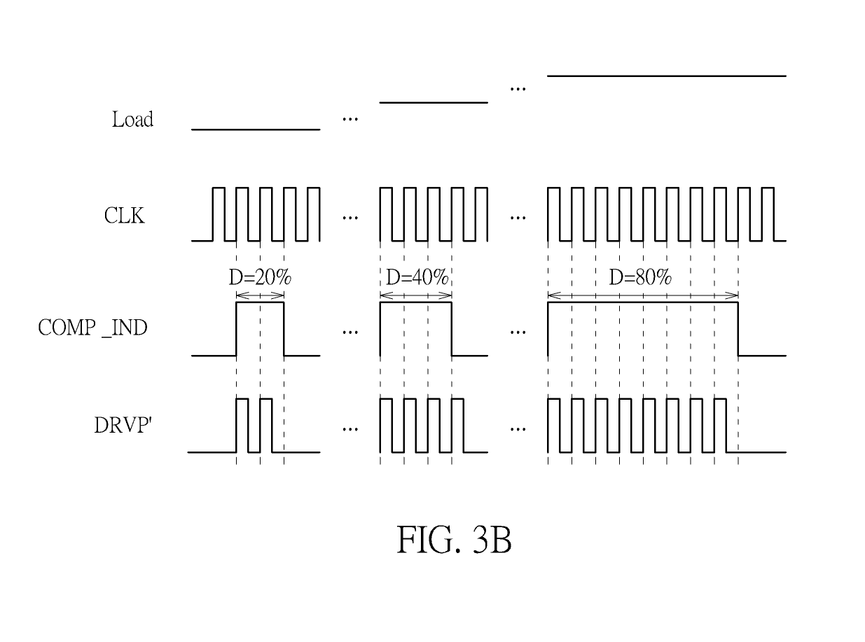

Please refer to FIG. 3A, which is a schematic diagram of a charge pump device 30 according to an embodiment. As shown in FIG. 3A, the charge pump device 30 comprises a driving stage 302, a charge pump circuit 304, a comparison circuit 306, a duty cycle detecting circuit 308 and a driving capability control circuit 310.

In short, the driving stage 302 generates a driving signal DRVP′ corresponding to a driving capability. The charge pump circuit 304 generates an output voltage VGH′ according to the driving signal DRVP′. The comparison circuit 306 generates a comparing signal COMP according to the output voltage VGH′ and a reference voltage VREF1 (a feedback voltage FBP′ can be a division voltage of the output voltage VGH′, and the reference voltage VREF1 can be related to a target voltage). The duty cycle detecting circuit 308 detects a length of a duty cycle D of an indicating signal COMP_IND indicating the comparison result COMP, to generate a detecting result DET indicating the length of the duty cycle D. The driving capability control circuit 310 is coupled between the duty cycle detecting circuit 308 and the driving stage 302, and control a driving capability corresponding to the driving signal DRVP′ according to the detecting result DET in an operating period.

In such a situation, please refer to FIG. 3B, which is a schematic diagram of the duty cycle D of the indicating signal COMP_IND under different loads according to an embodiment. As shown in FIG. 3B, the duty cycle D is short when the load is small and the duty cycle D is long when the load is heavy (the duty cycle D is a high voltage level time divided by the high voltage level time plus a low voltage level in the indicating signal COMP_IND, i.e. a ratio of the high voltage level time between two rising edges in the indicating signal COMP_IND), such that a small duty cycle D indicates a current driving capability is too strong (i.e. the output voltage VGH′ can be maintained at a target voltage by triggering the driving signal DRVP′ to a high voltage level less times) and causes a larger output ripple. On the other hand, a great duty cycle D indicates a current driving capability is too week (i.e. the output voltage VGH′ can be maintained at the target voltage only by triggering the driving signal DRVP′ to the high voltage level many times) and loading regulation is less enough. Therefore, the driving capability control circuit 310 can control the driving capability corresponding to the driving signal DRVP′ according to the detecting result DET indicating the length of the duty cycle D, such that the duty cycle D is maintained in a proper interval and thus a proper driving capability is provided. As a result, the embodiment can control driving capability according to the length of the duty cycle D, to maintain the duty cycle D in a proper interval and provides a proper driving capability, to have small output ripple and enough loading regulation, and thus balance output ripple and loading regulation.

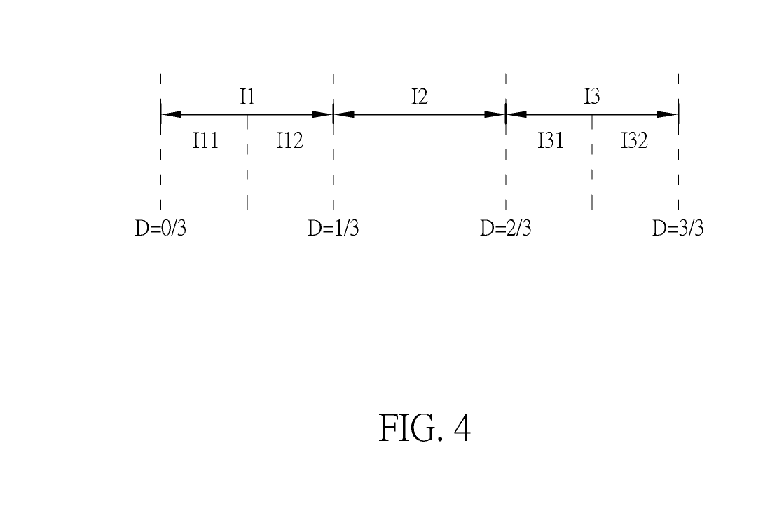

In detail, please refer to FIG. 4, which is a schematic diagram of intervals I1-I3 of the duty cycle D according to an embodiment. As shown in FIG. 4, the detecting result DET indicates the duty cycle D is within one of the intervals I1-I3, and the interval I1 is lower than the interval I2 and the interval I2 is lower than the interval I3. For example, the interval I1 can be designed as 0-1/3, the interval I2 can be designed as 1/3-2/3 and the interval I3 can be designed as 2/3-1. However, length of each interval can be designed according to practical requirement. When the detecting result DET indicates the duty cycle D is within the intervals I1-I3, the driving capability control circuit 310 decreases, maintains and increases the driving capability corresponding to the driving signal DRVP′, respectively. As a result, the embodiment can maintain the duty cycle Din the proper interval I2 and have a proper driving capability, to have small output ripple and enough loading regulation, and thus balance output ripple and loading regulation of performance.

Noticeably, when the detecting result DET indicates the duty cycle D is within the interval I1, the adjusting manner of the driving capability control circuit 310 decreasing the driving capability corresponding to the driving signal DRVP′ can be that the driving capability control circuit 310 decreases the driving capability corresponding to the driving signal DRVP′ with a fixed decreasing amount when the detecting result DET indicates the duty cycle D is any duty cycle within the interval I1; otherwise, the interval I1 can further comprise a plurality of sub-the intervals I11-I12 and each of the sub-intervals I11-I12 respectively corresponding to a different decreasing amount, and the adjusting manner can be that the driving capability control circuit 310 decreases the driving capability corresponding to the driving signal DRVP′ with a decreasing amount corresponding to a sub-interval I1x among the sub-the intervals I11-I12 when the detecting result DET indicate the duty cycle D is within the sub-interval I1x (e.g. the sub-interval I11 can be corresponding to a greater decreasing amount than that of the sub-interval I12, to decrease the driving capability corresponding to the driving signal DRVP′ rapidly to maintain the duty cycle D in the interval I2).

Similarly, when the detecting result DET indicates the duty cycle D is within the interval I3, the adjusting manner of the driving capability control circuit 310 increasing the driving capability corresponding to the driving signal DRVP′ can be that the driving capability control circuit 310 increases the driving capability corresponding to the driving signal DRVP′ with a fixed increasing amount when the detecting result DET indicates the duty cycle D is any duty cycle within the interval I3; otherwise, the interval I3 can further comprise a plurality of sub-the intervals I31-I32 and each of the sub-intervals I31-I32 respectively corresponding to a different increasing amount, and the adjusting manner can be that the driving capability control circuit 310 increases the driving capability corresponding to the driving signal DRVP′ with an increasing amount corresponding to a sub-interval I3x among the sub-the intervals I31-I32 when the detecting result DET indicate the duty cycle D is within the sub-interval I3x (e.g. the sub-interval I32 can be corresponding to a greater increasing amount than that of the sub-interval I31, to increase the driving capability corresponding to the driving signal DRVP′ rapidly to maintain the duty cycle D in the interval I2).

Noticeably, in this embodiment, the duty cycle is divided into three intervals, but other embodiments are not limited to this and can have fewer or more intervals, to achieve rougher or more precise adjustment.

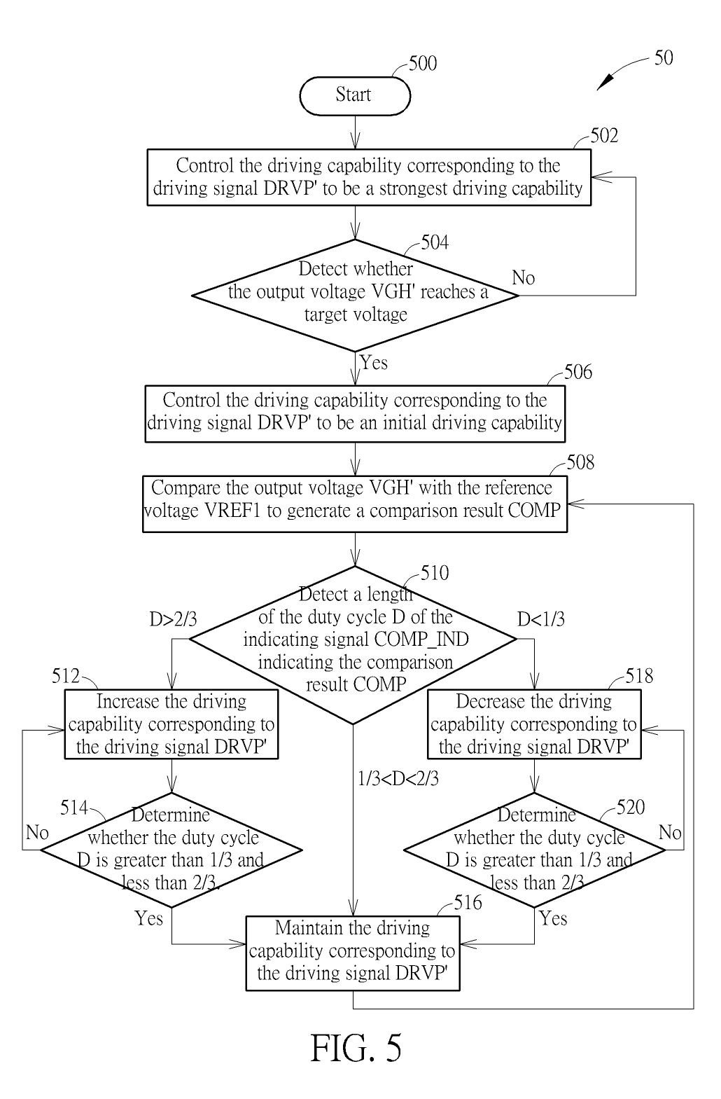

Detailed operations of the charge pump device 30 of FIG. 3A are shown in FIG. 5, which is a schematic diagram of a driving capability adjustment process 50 according to an embodiment. The driving capability adjustment process 50 comprises following steps:

Step 500: Start.

Step 502: Control the driving capability corresponding to the driving signal DRVP′ to be a strongest driving capability in a start-up period before an operating period.

Step 504: Detect whether the output voltage VGH′ reaches a target voltage in the start-up period. If yes, go to Step 506; otherwise, go to Step 502.

Step 506: Control the driving capability corresponding to the driving signal DRVP′ to be an initial driving capability to enter the operating period.

Step 508: Compare the output voltage VGH′ of the charge pump device 30 with the reference voltage VREF1 to generate a comparison result COMP in the operating period.

Step 510: Detect a length of the duty cycle D of the indicating signal COMP_IND indicating the comparison result COMP. If the duty cycle D is within the interval I3 (e.g. greater than 2/3), go to Step 512; if the duty cycle D is within the interval I2 (e.g. greater than 1/3 and less than 2/3), go to Step 516; if the duty cycle D is within the interval I1 (e.g. less than 1/3), go to Step 518.

Step 512: Increase the driving capability corresponding to the driving signal DRVP′.

Step 514: Determine whether the duty cycle D is within the interval I2 (e.g. greater than 1/3 and less than 2/3). If yes, go to Step 516; otherwise, go to Step 512.

Step 516: Maintain the driving capability corresponding to the driving signal DRVP′.

Step 518: Decrease the driving capability corresponding to the driving signal DRVP′.

Step 520: Determine whether the duty cycle D is within the interval I2 (e.g. greater than 1/3 and less than 2/3). If yes, go to Step 516; otherwise, go to Step 518.

According to the driving capability adjustment process 50, the driving capability control circuit 310 controls the driving capability corresponding to the driving signal DRVP′ to be a specific driving capability, which is preferably a strongest driving capability but not limited to this, in an start-up period before an operating period. Then, the duty cycle detecting circuit 308 continues detecting the indicating signal COMP_IND indicating the comparison result COMP, to generate the detecting result DET to indicate whether the output voltage VGH generated by the charge pump circuit 304 according to the driving signal DRVP′ corresponding to the strongest driving capability reaches a target voltage (i.e. the output voltage VGH′ becomes greater than the reference voltage VREF1). If the output voltage VGH′ does not reach the target voltage, the driving capability control circuit 310 controls the driving capability corresponding to the driving signal DRVP′ continue to be the strongest driving capability for performing driving. If the output voltage VGH′ reaches the target voltage, the driving capability control circuit 310 controls the driving capability corresponding to the driving signal DRVP′ to be an initial driving capability (the initial driving capability can be set as any driving capability). In other words, in the start-up period, the driving capability control circuit 310 sets the driving capability to be the strongest driving capability for driving before the output voltage VGH′ reaches the target voltage.

In the operating period, the comparison circuit 306 compares the output voltage VGH′ of the charge pump device 30 and the reference voltage VREF1, to generate the comparison result COMP. The duty cycle detecting circuit 308 detects a length of the duty cycle D of the indicating signal COMP_IND indicating the comparison result COMP. If the duty cycle D is within the interval I2 (e.g. greater than 1/3 and less than 2/3), the driving capability control circuit 310 maintains the driving capability corresponding to the driving signal DRVP′.

On the other hand, if the duty cycle D is within the interval I3 (e.g. greater than 2/3), the driving capability control circuit 310 increases the driving capability corresponding to the driving signal DRVP′. After the charge pump device 30 performs driving with the increased driving capability, for example, for a specific time, the duty cycle detecting circuit 308 detects the length of the duty cycle D of the indicating signal COMP_IND indicating the comparison result COMP again. If the duty cycle D is still not within the interval I2 (e.g. greater than 1/3 and less than 2/3), the driving capability control circuit 310 continues to increase the driving capability corresponding to the driving signal DRVP′ until the duty cycle D is within the interval I2 (e.g. greater than 1/3 and less than 2/3) and thus the driving capability control circuit 310 maintains the driving capability corresponding to the driving signal DRVP′. After the driving capability control circuit 310 maintains the driving capability corresponding to the driving signal DRVP′, the comparison circuit 306 and the duty cycle detecting circuit 308 still continue performing comparison and detection, to maintain the duty cycle D within the interval I2 (e.g. greater than 1/3 and less than 2/3).

Similarly, if the duty cycle D is within the interval I1 (e.g. less than 1/3), the driving capability control circuit 310 decreases the driving capability corresponding to the driving signal DRVP′. After the charge pump device 30 performs driving with the decreased driving capability, for example, for a specific time, the duty cycle detecting circuit 308 detects the length of the duty cycle D of the indicating signal COMP_IND indicating the comparison result COMP again. If the duty cycle D is still not within the interval I2 (e.g. greater than 1/3 and less than 2/3), the driving capability control circuit 310 continues to decrease the driving capability corresponding to the driving signal DRVP′ until the duty cycle D is within the interval I2 (e.g. greater than 1/3 and less than 2/3) and thus the driving capability control circuit 310 maintains the driving capability corresponding to the driving signal DRVP′. After the driving capability control circuit 310 maintains the driving capability corresponding to the driving signal DRVP′, the comparison circuit 306 and the duty cycle detecting circuit 308 still continue performing comparison and detection, to maintain the duty cycle D within the interval I2 (e.g. greater than 1/3 and less than 2/3).

Noticeably, the spirit of this embodiment is to control driving capability according to the length of the duty cycle D related to the comparison result COMP of the output voltage VGH′ and the reference voltage VREF1, to maintain the duty cycle D within a proper interval and have a proper driving capability, so as to have small output ripple and enough loading regulation, and thus balance output ripple and loading regulation. Those skilled in the art can make modifications or alterations accordingly. For example, FIG. 4 illustrates that the intervals I1-I3 have the same width, wherein the interval I1 is 0-1/3, the interval I2 is 1/3-2/3 and the interval I3 is 2/3-1, but in other embodiments, the intervals I1-I3 can be set as other intervals with different values and different widths, e.g. the interval I1 is 0%-60%, the interval I2 is 60%-80% and the interval I3 is 80%-100%, to have smaller output ripple and still have enough loading regulation. Therefore, the intervals I1-I3 are not limited to specific intervals as long as respectively decreasing, maintaining and increasing the driving capability corresponding to the driving signal DRVP′ when the duty cycle D is within intervals I1-I3, so as to maintain the duty cycle D in the interval I2. Besides, if the load is too heavy in the operating period, the output voltage VGH′ may continue to be not able to reach the target voltage and thus the indicating signal COMP_IND indicating the comparison result COMP continues to be high voltage level, the embodiment can automatically determine the duty cycle D within the interval I3 and increase the driving capability corresponding to the driving signal DRVP′.

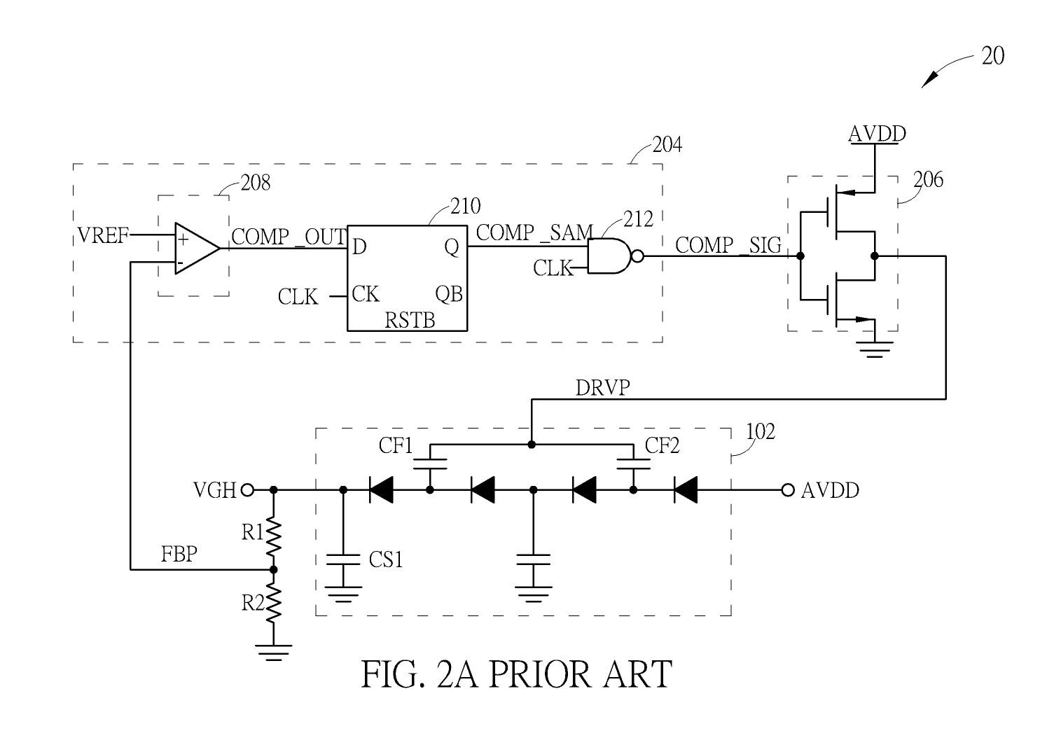

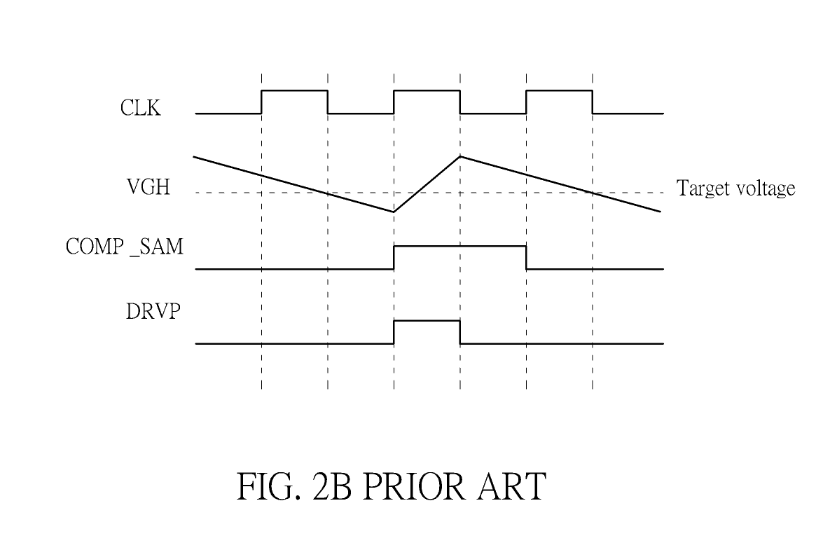

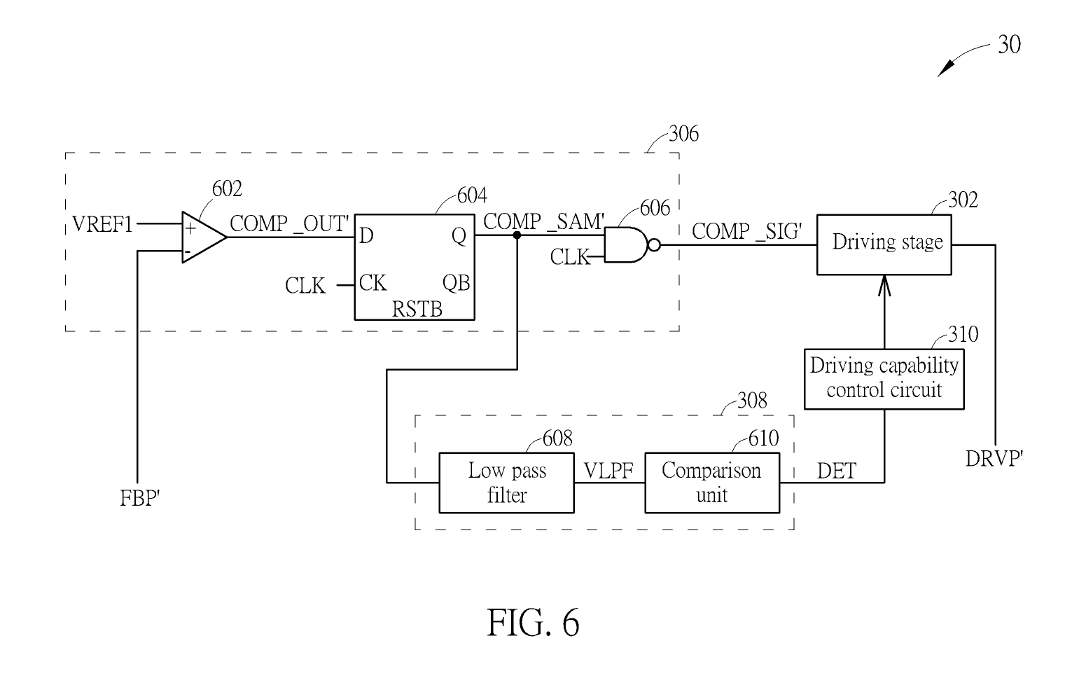

Moreover, the comparison circuit 306, the duty cycle detecting circuit 308 and the driving capability control circuit 310 can be realized by circuit as long as respective functionalities can be achieved. For example, please refer to FIG. 6, which is a schematic diagram of partial circuit of the charge pump device 30 according to an embodiment. As shown in FIG. 6, the comparison circuit 306 shown in FIG. 6 is similar to the comparison circuit 204 shown in FIG. 2A, and thus elements and signals with similar functions are denoted with the same symbols. As shown in FIG. 6, the comparison circuit 306 comprises a comparator 602, a flip-flop 604 and a NAND gate 604. The comparator 602 comprises two input terminals coupled the output voltage VGH′ (feedback voltage FBP′ is a division voltage of the output voltage VGH′) and the reference voltage VREF1, respectively, and an output terminal, for providing a comparing output signal COMP_OUT′. The flip-flop 604 comprises a reset terminal RSTB, a data input terminal D coupled to the output terminal of the comparator 602, a clock terminal CK for receiving a clock signal CLK, and a data output terminal Q, for providing a comparison sample signal COMP_SAM′ (i.e. the flip-flop 604 may output the voltage level of the current comparison output signal COMP_OUT′ at the rising edges of the clock signal CLK, and thus the comparison sample signal COMP_SAM′ maintains at the same voltage level in a period of the clock signal CLK, which is different from the comparison output signal COMP_OUT′ may be interfered by external noise and varied the voltage level thereof). The NAND gate 604 comprises two input terminals coupling to the data output terminal Q of the flip-flop 604 and the clock signal CLK, respectively, and an output terminal, for providing a comparison result signal COMP_SIG′ (the comparing output signal COMP_OUT′, the comparison sample signal COMP_SAM′ and the comparison result signal COMP_SIG′ are substantially the same with the comparing output signal COMP_OUT, the comparison sample signal COMP_SAM and the comparison result signal COMP_SIG).

Noticeably, the above comparison result COMP includes at least one of the comparing output signal COMP_OUT′ and the comparison sample signal COMP_SAM′. In other words, although FIG. 6 illustrates that the duty cycle detecting circuit 308 receives the comparison sample signal COMP_SAM′ as the indicating signal COMP_IND, but in practice, the duty cycle detecting circuit 308 can receive the comparing output signal COMP_OUT′ or the comparison sample signal COMP_SAM′ (more stable) as the indicating signal COMP_IND.

Besides, as shown in FIG. 6, the duty cycle detecting circuit 308 includes a low pass filter 608 and a comparison unit 610. The low pass filter 608 performs low pass filtering on the indicating signal COMP_IND, to generate a filtered voltage VLPF, and the comparison unit 610 comprises a plurality of comparators capable of comparing the filtered voltage VLPF with a plurality of comparison voltage, to generate the detecting result DET. In such a situation, since the filtered voltage VLPF obtained from low pass filtering is proportional to the duty cycle D of the indicating signal COMP_IND multiplying the high voltage level of the indicating signal COMP_IND (e.g. when the duty cycle D is 50%, the filtered voltage VLPF is half of the high voltage level of the indicating signal COMP_IND), a plurality of comparing voltage can be set to specific duty cycles, respectively, (e.g. two comparing voltages are set to be 1/3 and 2/3 of the high voltage level of the indicating signal COMP_IND to be corresponding to the duty cycle D of 1/3 and 2/3). Thus, the plurality of comparators of the comparison unit 610 compare the filtered voltage VLPF with the plurality of comparison voltage performing to determine which interval the duty cycle D is within. Noticeably, if the load is too heavy in the operating period, the output voltage VGH′ may continue to be not able to reach the target voltage and thus the indicating signal COMP_IND indicating the comparison result COMP continues to be high voltage level, the filtered voltage VLPF will be greater than a maximum comparing voltage, such that the embodiment can automatically determine the duty cycle D within the interval I3 and increase the driving capability corresponding to the driving signal DRVP′. As a result, the duty cycle detecting circuit 308 can performing low pass filtering on the indicating signal COMP_IND, to generate the filtered voltage VLPF related to the duty cycle D, and then compare the filtered voltage VLPF with the plurality of comparison voltage to determine which interval the duty cycle D is within.

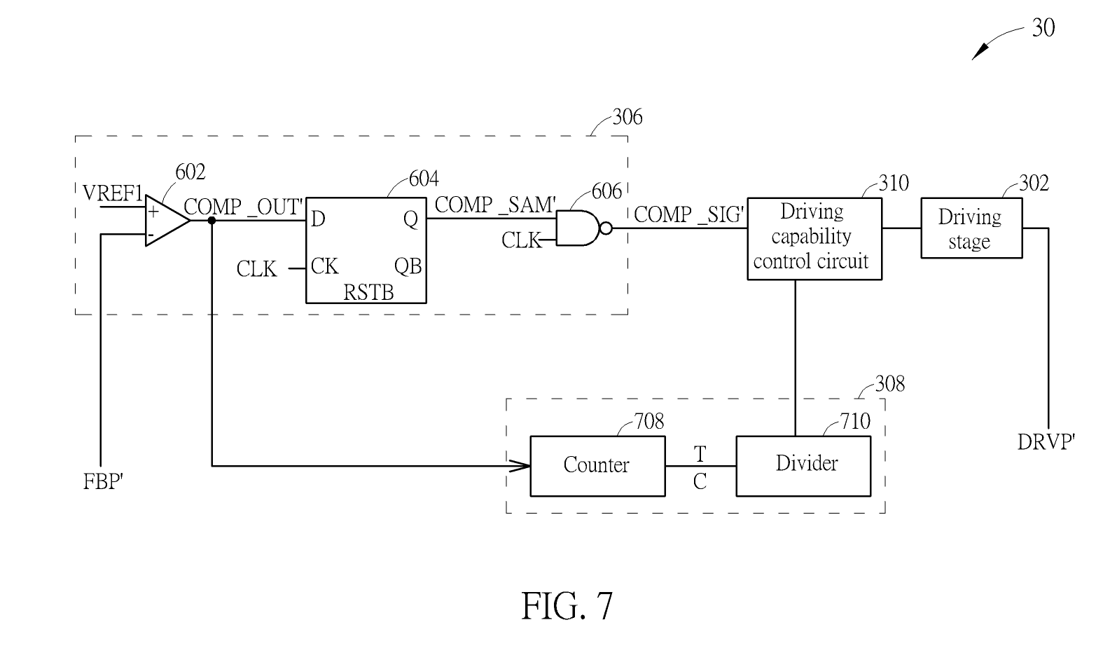

On the other hand, please refer to FIG. 7, which is a schematic diagram of partial circuit of the charge pump device 30 according to another embodiment. As shown in FIG. 7, the comparison circuit 306 shown in FIG. 7 is the same with the comparison circuit 306 shown in FIG. 6, and thus elements and signals are denoted with the same symbols, wherein the duty cycle detecting circuit 308 receives the comparing output signal COMP_OUT as the indicating signal COMP_IND, but in practice, the duty cycle detecting circuit 308 can receive the comparing output signal COMP_OUT′ or the comparison sample signal COMP_SAM′ (more stable) as the indicating signal COMP_IND.

Besides, as shown in FIG. 7, the duty cycle detecting circuit 308 includes a counter 708 and a divider 710. The counter 708 counts a period C of the indicate signal COMP_IND and a duration T which the indicate signal is a specific voltage level. The divider 710 divides the duration T by the period C of the indicate signal COMP_IND, to generate the detecting result DET. In such a situation, the specific voltage level can be a high voltage level of the indicating signal COMP_IND, such that the duration T counted by the counter 708 is the time when the indicating signal COMP_IND is at the high voltage level. Then, the counter 708 adds a duration when the indicating signal COMP_IND is at a low voltage level with the duration T to derive the period C, and the divider 710 divides the duration T by the period C of the indicating signal COMP_IND to obtain the detecting result DET indicating the length of the duty cycle D (the duty cycle detecting circuit 308 can also count the duration when the indicating signal COMP_IND is at the low voltage level to derive the detecting result DET indicating the duty cycle D). Noticeably, if the load is too heavy in the operating period, the output voltage VGH′ may continue to be not able to reach the target voltage and thus the indicating signal COMP_IND indicating the comparison result COMP continues to be high voltage level, the duration T counted by the counter 708 will be greater than the memory of the counter 708 and overflow. At this moment, the embodiment can automatically determine duration T equal to the period C, wherein the detecting result DET indicates the duty cycle D within the interval I3, and increases the driving capability corresponding to the driving signal DRVP′. As a result, the duty cycle detecting circuit 308 can count the indicating signal COMP_IND, to obtain the detecting result DET indicating the length of the duty cycle D.

Moreover, the driving capability control circuit 310 can adjusts the driving capability corresponding to the driving signal DRVP′ by adjusting at least one of a number of times the driving signal DRVP′ drives the charge pump 304 to continuously perform charging, a size of a transistor generating the driving signal DRVP′, and a number of transistors connected in parallel for generating the driving signal DRVP′. For example, the driving stage 302 shown in FIG. 6 can utilize transistors with different sizes generate the driving signal DRVP′, and the driving capability control circuit 310 controls the driving stage 302 to utilize a transistor with a corresponding size to generate the driving signal DRVP′ according to the length of the duty cycle D indicated by the detecting result DET; otherwise, the driving stage 302 can utilize different number of transistors connected in parallel to generate the driving signal DRVP′, and the driving capability control circuit 310 controls the driving stage 302 to utilize a corresponding number of transistors connected in parallel to generate the driving signal DRVP′ according to the length of the duty cycle D indicated by the detecting result DET. Besides, as shown in FIG. 7, other than the driving capability control circuit 310 coupled between the duty cycle detecting circuit 308 and the driving stage 302, the driving capability control circuit 310 can be further coupled between the comparison circuit 306 and the driving stage 302, to control the driving stage 302 to adjust a number of times the driving signal DRVP′ drives the charge pump 304 to continuously perform charging according to the length of the duty cycle D indicated by the detecting result DET (e.g. if an original driving capability is corresponding to only continuously performing charging three times, when the comparison result signal COMP_SIG′ indicates 6 continuous high voltage levels, the driving capability control circuit 310 transmits 3 high voltage levels for the driving stage 302 to generate the driving signal DRVP′, and then mask one or more high voltage levels not being transmitted. Afterward, the driving capability control circuit 310 transmits 2 or remaining high voltage levels for the driving stage 302 to generate the driving signal DRVP′. At this moment, if the detecting result DET indicating the duty cycle D is determined to increase the driving capability, the embodiment increases a number of times continuously performing charging; if the detecting result DET indicating the duty cycle D is determined to decrease the driving capability, the embodiment decreases a number of times continuously performing charging).

In the prior art, the output of the structure controlled by the operational amplifier has a pole varied with different external loadings and different output capacitors, causing concerns about instability. On the other hand, although the charge pump device controlled by the comparator is stable, the output thereof has greater output ripples, and the driving capability thereof may be insufficient for affording the loading if the output ripples are decreased via decreasing the driving capability of the driving signal.

In comparison, the above embodiment controls driving capability according to the length of the duty cycle D related to the comparison result COMP of the output voltage VGH′ and the reference voltage VREF1, to maintain the duty cycle D within a proper interval and have a proper driving capability, so as to have small output ripple and enough loading regulation, and thus balance output ripple and loading regulation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A charge pump device, comprising:
a driving stage, for generating a driving signal corresponding to a driving capability;
a charge pump circuit, for generating an output voltage according to the driving signal;
a comparison circuit, for generating a comparison result according to the output voltage and a reference voltage;
a duty cycle detecting circuit, for detecting a length of a duty cycle of an indicate signal indicating the comparison result of, to generate a detecting result indicating the length of the duty cycle; and
a driving capability control circuit, coupled between the duty cycle detecting circuit and the driving stage, for controlling the driving capability corresponding to the driving signal according to the detecting result in an operating period.

2. The charge pump device of claim 1, wherein the detecting result indicates the duty cycle is within one of a first interval, a second interval and a third interval, and the first interval is lower than the second interval and the second interval is lower than the third interval.

3. The charge pump device of claim 2, wherein the driving capability control circuit decreases, maintains and increases the driving capability corresponding to the driving signal, respectively, when the detecting result indicate the duty cycle within the first interval, the second interval and the third interval.

4. The charge pump device of claim 2, wherein the driving capability control circuit decreases the driving capability corresponding to the driving signal when the detecting result indicate the duty cycle is within the first interval.

5. The charge pump device of claim 4, wherein the driving capability control circuit decreases the driving capability corresponding to the driving signal with a fixed decreasing amount when the detecting result indicates the duty cycle is any duty cycle within the first interval.

6. The charge pump device of claim 4, wherein the first interval comprises a plurality of sub-interval, each of the sub-intervals respectively corresponding to a different decreasing amount, and the driving capability control circuit decreases the driving capability corresponding to the driving signal with a decreasing amount corresponding to a sub-interval among the plurality of sub-intervals when the detecting result indicates the duty cycle is within the sub-interval.

7. The charge pump device of claim 2, wherein the driving capability control circuit maintains the driving capability corresponding to the driving signal when the detecting result indicate the duty cycle is within the second interval.

8. The charge pump device of claim 2, wherein the driving capability control circuit increases the driving capability corresponding to the driving signal when the detecting result indicate the duty cycle is within the third interval.

9. The charge pump device of claim 8, wherein the driving capability control circuit increases the driving capability corresponding to the driving signal with a fixed increasing amount when the detecting result indicates the duty cycle is any duty cycle within the third interval.

10. The charge pump device of claim 8, wherein the third interval comprises a plurality of sub-interval, each of the sub-intervals respectively corresponding to a different increasing amount, and the driving capability control circuit increases the driving capability corresponding to the driving signal with an increasing amount corresponding to a sub-interval among the plurality of sub-intervals when the detecting result indicates the duty cycle is within the sub-interval.

11. The charge pump device of claim 1, wherein the driving capability control circuit controls the driving capability corresponding to the driving signal to be a strongest driving capability in an start-up period before the operating period of the charge pump device.

12. The charge pump device of claim 9, wherein the driving capability control circuit controls the driving capability corresponding to the driving signal to be an initial driving capability when the output voltage generated by the charge pump circuit according to the driving signal corresponding to the strongest driving capability reaches a target voltage in the start-up period of the charge pump device.

13. The charge pump device of claim 1, wherein the duty cycle circuit comprises:
a low pass filter, for performing low pass filtering on the indicate signal, to generate a filtered voltage; and
a comparison unit, comprising a plurality of comparators, for comparing the filtered voltage with a plurality of comparison voltage, to generate the detecting result.

14. The charge pump device of claim 1, wherein the duty cycle circuit comprises:
a counter, for counting a period of the indicate signal and a duration which the indicate signal is a specific voltage level; and
a divider, for dividing the duration by the period of the indicate signal, to generate the detecting result.

15. The charge pump device of claim 1, wherein the comparison circuit includes:
a comparator, comprising two input terminals coupled to the output voltage and the reference voltage, respectively, and an output terminal for providing a comparison output signal;
a flip-flop, comprising a data input terminal coupled to the output terminal of the comparator, a clock terminal for receiving a clock signal, and a data output terminal for providing a comparison sample signal; and
a NAND gate, comprising two input terminals coupled to the data output terminal of the flip flop and the clock signal, respectively, and an output terminal for providing a comparison result signal, wherein the comparison result comprises at least one of the comparison output signal and the comparison sample signal.

16. The charge pump device of claim 15, wherein the duty cycle detecting circuit receives the comparison output signal or the comparison sample signal as the indicate signal.

17. The charge pump device of claim 1, wherein the driving capability control circuit adjusts the driving capability corresponding to the driving signal by adjusting at least one of a number of times the driving signal drives the charge pump to continuously perform charging, a size of a transistor generating the driving signal, and a number of transistors connected in parallel for generating the driving signal.

18. A driving capability adjustment method, for a charge pump device, comprising:
(i) comparing an output voltage of the charge pump device with a reference voltage to generate a comparison result in an operating period; and
(ii) detecting a length of a duty cycle of an indicate signal indicating the comparison result of, to set a driving capability to drive the charge pump device.

19. The driving capability adjustment method of claim 18 further comprising:
setting the driving capability to be a strongest driving capability to drive the charge pump device according to whether the output voltage of the charge pump circuit reaches a target voltage in a start-up period before the operating period;
detecting whether the output voltage reaches the target voltage; and
controlling the driving capability corresponding to the driving signal to be an initial driving capability to enter the operating period if the output voltage reaches the target voltage.

20. The driving capability adjustment method of claim 18, wherein the step (ii) comprises:
detecting the duty cycle is within which one of a first interval, a second interval and a third interval, wherein the first interval is lower than the second interval and the second interval is lower than the third interval; and
decreasing, maintaining and increasing the driving capability corresponding to the driving signal, respectively, when the detecting result indicate the duty cycle within the first interval, the second interval and the third interval.
